(19) United States
(12) Patent Application Publication
(10) Pub. No.: US 2004/0139394 A1
(43) Pub. Date: Jul. 15, 2004

(54) Data storage medium having information for controlling buffered state of markup document, and method and apparatus for reproducing data from the data storage medium

(75) Inventors: Hyun-kwon Chung, Seoul (KR); Jung-kwon Heo, Seoul (KR); Jung-wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/686,521

(22) Filed: Oct. 16, 2003

(30) Foreign Application Priority Data
Oct. 17, 2002 (KR) 2002-63631
Apr. 29, 2003 (KR) 2003-27073
Aug. 25, 2003 (KR) 2003-58695
Aug. 25, 2003 (KR) 2003-58890
Aug. 25, 2003 (KR) 2003-58891
Aug. 25, 2003 (KR) 2003-58892
Aug. 25, 2003 (KR) 2003-58893
Sep. 1, 2003 (KR) 2003-60760

(51) Int. Cl. G06F 17/21

(52) U.S. Cl. 715/513

(57) ABSTRACT

An apparatus which reproduces AV data using a markup document in an interactive mode includes a buffer which buffers the markup document, and a buffer manager which manages preloading of the markup document and provides buffering state information of the buffer in response to a report signal. The markup document may be provided via a network or form a data storage medium which includes information to control a buffering state of the markup document.

### CROSS-REFERENCE TO RELATED APPLICATION

This application claims the benefit of Korean Patent Application Nos. 2002-63631, 2003-27073, 2003-58695, 2003-58890, 2003-58891, 2003-58892, 2003-58893 and 2003-60760 filed on Oct. 17, 2002, Apr. 29, 2003, Aug. 25, 2003, Aug. 25, 2003, Aug. 25, 2003, Aug. 25, 2003, Aug. 25, 2003 and Sep. 1, 2003, respectively, in the Korean Intellectual Property Office, the disclosures of which are incorporated herein by reference.

### BACKGROUND OF THE INVENTION

1. Field of the Invention

The present invention relates to a data storage medium having information used to control a buffering state of a mark-up document, and a method and an apparatus for reproducing data from the data storage medium.

2. Description of the Related Art

Interactive DVDs having markup documents to reproduce content thereof in an interactive mode are being commercialized in the market. Generally, content recorded on an interactive DVD is reproduced in two different modes. One of the two modes is a video mode, in which the content is displayed in the same manner as that of data recorded on a general DVD. The other mode is an interactive mode, in which the content is displayed through a display window defined by markup documents of the interactive DVD.

Where a user selects an interactive mode, a web browser installed in a DVD player displays the markup documents recorded on the interactive DVD. Content selected by the user is displayed through the display window defined by the mark-up documents. For example, where the content is a movie title, a movie is displayed in the display window on a screen, and various pieces of additional information, for example, the scenario, synopsis, and actors' and actresses' photos, may be displayed on the rest of the screen. Such additional information includes image files or text files.

FIG. 1 shows an interactive DVD on which audio video (AV) data is recorded. The AV data and a plurality of markup documents are recorded on tracks of the interactive DVD, in a form of an MPEG bitstream. Here, the markup documents may include markup resources including various image files or graphic files to be inserted into the markup documents.

FIG. 2 illustrates discontinuous reproduction of data from the interactive DVD of FIG. 1. That is, FIG. 2 shows the occupancy of a buffer memory, which is used to buffer AV data, and the occupancy of a cache memory, which is used to cache web resources.

Referring to FIGS. 1 and 2, a method of loading AV data into a memory and displaying the AV data will be described. A pickup device searches for a markup document STARTUP.HTM and loads the searched markup document STARTUP.HTM into a cache memory. Thereafter, the STARTUP.HTM is activated. At the same time, AV data \mathring{1} selected by a user is loaded into a buffer memory and then displayed. Thereafter, AV data \mathring{2} is loaded into the buffer memory and then displayed. Where a buffering of the AV data \mathring{2} is complete, the pickup device jumps to a place on the interactive DVD where AV data \mathring{3} is recorded and starts buffering the AV data \mathring{3}. At this time, the user may request a markup document \mathring{4} A.HTM. In this case, the pickup device stops buffering the AV data \mathring{3}, searches for the markup document \mathring{4} A.HTM, and loads the markup document \mathring{4} A.HTM into the cache memory. While searching for the markup document \mathring{4} A.HTM and loading it into the cache memory, the AV data \mathring{3} is kept from being displayed. Therefore, the amount of data that can be buffered in the buffer memory is drastically decreased as the AV data \mathring{3} still occupies the space in the buffer memory. Where the markup document \mathring{4} A.HTM is activated, and the buffering of the AV data \mathring{3} is complete, AV data \mathring{5} is buffered. Thereafter, the pickup device jumps to a place where AV data \mathring{6} is recorded. In the above method, all the data that has been buffered so far may disappear. In other words, where a reproduction of DVD-video images from a conventional interactive DVD in synchronization with markup documents is requested, for example, where a display of a specific actor's or actress's personal history whenever he or she appears on a screen is requested, the pickup device stops buffering AV data and begins searching for and caching the associated markup documents, and thus images may be discontinuously reproduced.

### SUMMARY OF THE INVENTION

Accordingly, it is an aspect of the present invention to provide a data storage medium comprising control information to control a buffering state of markup documents that are used to reproduce AV data in an interactive mode, and an apparatus and a method to reproduce the AV data from the data storage medium.

Additional aspects and/or advantages of the present invention will be set forth in part in the description which follows and, in part, will be obvious from the description, or may be learned by practice of the invention.

To achieve the above and/or other aspects of the present invention, there is provided an apparatus for reproducing AV data using a markup document in an interactive mode, comprising a buffer which buffers the markup document, and a buffer manager which manages the buffer to preload the markup document and outputs buffering state information of the buffer in response to a report signal.

The apparatus may further comprise a content decoder which interprets the markup document and outputs the report signal, wherein the buffer manager informs the content decoder of the buffering state information of the buffer in response to the report signal. The content decoder may generate the report signal using an application program interface (API).

The API may serve to notify the content decoder of whether preloading of the markup document succeeded or failed, or whether the markup document is still being loaded. The API may return a value of 0 where the preloading of the markup document succeeded, return a value of 1 where the preloading of the markup document failed, and return a value of 2 where the markup document is still being loaded. The buffer manager may inform the content decoder of a buffering state of the markup document utilizing the API.

The content decoder may generate the report signal using an API, which includes at least one of a file path and an attribute of the markup document as a parameter. The API may be an [obj].isCached(URL, resType) API, where the URL is a parameter indicating a file path of the markup document and the resType is a parameter indicating an attribute of the markup document.

The buffer manager may preload the markup document into the buffer in response to a fetch signal. The content decoder may output the fetch signal, and the buffer manager may inform the content decoder of whether a command to preload the markup document, included in the fetch signal, has been successfully received. The content decoder may generate the fetch signal using an API.

The content decoder may check whether preloading of the markup document is completed using an API. The API may be an [obj].allDone API. The [obj].allDone API may return a value of true to the content decoder where the preloading of the markup document is completed and return a value of false to the content decoder where the preloading of the markup document is not completed.

The buffer manager may transfer the markup document from the buffer to the content decoder in response to a reproduce signal.

The content decoder may output a release signal to the buffer manager indicating that the markup document therein brought from the buffer, in response to a reproduce signal, is not in use.

The buffer manager may delete the markup document from the buffer in response to a discard signal output from the content decoder. The content decoder may generate the discard signal using a discard API.

The content decoder may generate the report signal using a progressNameOfFlie API to determine a file name of the markup document currently being preloaded. The content decoder may generate the report signal using a progressLengthOfFile API to determine how much of the markup document currently being preloaded has been preloaded. The content decoder may generate the report signal using a remainLengthOfFile API to determine out how much of the markup document currently being preloaded is yet to be preloaded. The content decoder may generate the report signal using a totalLoadingSize API to determine a total load of the markup document to be preloaded. The content decoder may generate the report signal using a remainLoadingSize API to determine how much of a total load of the markup document is yet to be preloaded.

To achieve the above and/or other aspect of the present invention, there is provided another apparatus for controlling a buffer which buffers a markup document to reproduce AV data in an interactive mode, comprising a buffer manager which manages the buffer to preload the markup document and outputs information of the buffer including buffering information of the markup document, wherein the buffering information includes information indicating that preloading of the markup document succeeded, information indicating that the preloading of the markup document failed, and information indicating that the preloading of the markup document is still be conducted.

The information of the buffer may further include information indicating whether a command to preload the markup document has been successfully received. The information of the buffer may further include information indicating whether preloading of the markup document is completed.

To achieve the above and/or other aspect of the present invention, there is provided still another apparatus for recording and/or reproducing AV data using a markup document in an interactive mode, comprising an AV buffer which buffers the AV data, an AV reproduction engine which decodes the AV data, an enhanced audio video (ENAV) buffer which preloads the markup document to reproduce the AV data in the interactive mode, an ENAV engine which identifies buffering state information of the markup document and decodes the markup document, and means for obtaining the markup document.

The apparatus may use a blocked I/O method in response to obtaining the markup document from a data storage medium and an unblocked I/O method in response to obtaining the markup document from a network.

To achieve the above and/or other aspect of the present invention, there is provided a method of reproducing AV data in an interactive mode using a markup document, the method comprising buffering the markup document to preload the markup document, and outputting buffering state information of the markup document in response to a report signal. The method may further comprise reproducing the AV data in the interactive mode using the preloaded markup document.

The outputting of the buffering state information may include returning a value of 0 in response to the markup document being successfully preloaded, returning a value of 1 in response to the markup document not being successfully preloaded, and returning a value of 2 in response to the markup document still being preloaded.

To achieve the above and/or other aspect of the present invention, there is provided another method of reproducing AV data in an interactive mode using a markup document, the method comprising issuing a command to preload the markup document using a fetch signal, and receiving a response indicating whether the command to preload the markup document has been successfully transmitted using the fetch signal. The method may further comprise reproducing the AV data in the interactive mode using the preloaded markup document.

To achieve the above and/or other aspect of the present invention, there is provided still another method of reproducing AV data in an interactive mode using a markup document, the method comprising inquiring whether preloading of the markup document is completed using an application program interface (API), and receiving a return value of true in response to the preloading of the markup document being completed and a return value of false in response to the preloading of the markup document being not completed. The method may further comprise reproducing the AV data in the interactive mode using the preloaded markup document.

To achieve the above and/or other aspect of the present invention, there is provided a method of managing a markup document for use in reproducing AV data in an interactive mode, the method comprising buffering the markup document to preload the markup document in response to a fetch signal, outputting a buffering state of the markup document in response to a report signal, staging the markup document for decoding in response to a retrieve signal, and deleting the markup document in response to a discard signal.

The method may further comprise marking the markup document as a document no longer in use in response to a release signal. The method may further comprise issuing a response indicating whether a command to preload the markup document included in the fetch signal has been successfully transmitted.

The outputting of the buffering state may comprise returning a signal indicating whether preloading of the markup document has been completed. The outputting of the buffering state may comprise returning a signal indicating whether preloading of the markup document succeeded or failed, or whether the preloading of the markup document is still being conducted.

To achieve the above and/or other aspect of the present invention, there is provided another method of managing a markup document for use in reproducing AV data in an interactive mode, the method comprising generating a fetch signal to preload the markup document, generating a report signal to determine a buffering state of the markup document, generating a retrieve signal to stage the markup document for decoding, and generating a discard signal to delete the markup document.

The method may further comprise generating a release signal in response the markup document no longer being presented. The generating of the report signal may comprise generating the report signal using an application program interface (API) to determine one or more of whether preloading of the markup document succeeded, whether the markup document is still being preloaded, and whether the preloading of the markup document has been completed.

To achieve the above and/or other aspect of the present invention, there is provided a computer readable medium encoded with operating instructions for implementing one or more methods disclosed above, performed by a computer.

To achieve the above and/or other aspect of the present invention, there is provided a method in a computer system to process AV data in an interactive mode using a markup document, the method comprising controlling a content decoder to generate a report signal to determine buffering state information of the markup document, and in response to the report signal, controlling a buffer manager to issue a response indicating whether preloading of the markup document succeeded or failed, or whether the preloading of the markup document is still being conducted.

To achieve the above and/or other aspect of the present invention, there is provided another method in a computer system to process AV data in an interactive mode using a markup document, the method comprising controlling a content decoder to generate a fetch signal to preload the markup document, and in response to the fetch signal, controlling a buffer manager to issue a response indicating whether a command to preload the markup document has been successfully received.

To achieve the above and/or other aspect of the present invention, there is provided still another method in a computer system to process AV data in an interactive mode using a markup document, the method comprising controlling a content decoder to generate an inquiry to determine whether preloading of the markup document is completed, and in response to the inquiry, controlling a buffer manager to issue a response indicating whether the preloading of the markup document is completed.

To achieve the above and/or other aspect of the present invention, there is provided a data storage medium, comprising AV data, a markup document which is provided to reproduce the AV data in an interactive mode, and control information which is provided to identify buffering state information of the markup document to be preloaded.

The control information may include an application program interface (API) that generates a report signal used to identify a buffering state of the markup document. The API may be an [obj].isCached(URL, resType) API that generates a report signal, where the URL is a parameter indicating a file path of the markup document and the resType is a parameter indicating an attribute of the markup document.

The control information may include an API that returns a value of 0 in response to preloading of the markup document being successful, a value of 1 in response to the preloading of the markup document being failed, and a value of 2 in response to the preloading of the markup document still being conducted.

The control information may include an API that generates a fetch signal used to issue a command to preload the markup document. The API may return a response indicating whether the command to preload the markup document has been successfully transmitted using the fetch signal.

The control information may include an API that is used to determine whether preloading of the markup document is completed.

To achieve the above and/or other aspect of the present invention, there is provided a data storage medium encoded with program codes for enabling a method of reproducing AV data in an interactive mode using markup documents, performed by a computer, the data storage medium comprising a first program code to carry out buffering of the markup documents to preload the markup documents, and a second program code to output information indicating whether the buffering of the markup documents is completed.

To achieve the above and/or other aspect of the present invention, there is provided another data storage medium encoded with program codes for enabling a method of reproducing AV data in an interactive mode using markup documents, performed by a computer, the data storage medium comprising a first program code which issues a command to preload the markup documents using a fetch signal, and a second program code which informs whether the command to preload the markup documents has been successfully issued using the fetch signal.

To achieve the above and/or other aspect of the present invention, there is provided still another a data storage medium encoded with program codes for enabling a method of reproducing AV data in an interactive mode using markup documents, performed by a computer, the data storage medium comprising a first program code which is used for a content decoder to check whether a buffer manager has completed preloading of the markup documents by using an application program interface (API), and a second program code which returns a value of true to the content decoder in response to the preloading of the markup documents being successfully completed by the buffer manager by using the API, and otherwise, returns a value of false to the content decoder.

### BRIEF DESCRIPTION OF THE DRAWINGS

These and/or other aspects and advantages of the invention will become apparent and more readily appreciated from the following description of the aspects of the present invention, taken in conjunction with the accompanying drawings of which:

FIG. 1 is a diagram illustrating an interactive DVD on which AV data is recorded;

FIG. 2 is a diagram illustrating discontinuous reproduction of data from the interactive DVD shown in FIG. 1;

FIG. 3 is a block diagram of an apparatus for reproducing data from a data storage medium that carries out a preloading or deleting operation with respect to markup documents;

FIG. 4 is a diagram illustrating a directory structure of a DVD 300 that supports the preloading or deleting with respect to the markup documents;

FIG. 5 is a diagram illustrating a volume space of the DVD 300 that supports the preloading or deleting with respect to the markup documents;

FIG. 6 is a flowchart illustrating a method of preloading or deleting markup documents;

FIG. 7 is a flowchart illustrating a method of interpreting preload information, that is, operation 602 of FIG. 6;

FIG. 8 is a flowchart illustrating a method of preloading target files, that is, operation 603 of FIG. 6;

FIG. 9A is a flowchart illustrating another method of preloading target files, that is, operation 603 of FIG. 6;

FIG. 9B is a flowchart illustrating still another method of preloading target files, that is, operation 603 of FIG. 6;

FIG. 10 is a flowchart illustrating a method of deleting at least one target file that is preloaded and stored in a memory;

FIG. 11 is a flowchart illustrating a method of deleting a file from a cache memory, that is, operation 1002 of FIG. 10;

FIG. 12 is a diagram illustrating the effects of a preloading technique described with respect to FIGS. 3 through 11, where AV data and HTML documents are recorded on an interactive DVD in the same manner as in FIG. 1;

FIGS. 13 and 14 are block diagrams of an apparatus for reproducing data from a data storage medium according to an embodiment of the present invention;

FIG. 15 is a diagram illustrating a method of managing a buffering state of a markup document in a cache memory using a cache manager according to an embodiment of the present invention;

FIG. 16 is a flowchart illustrating a method of controlling a buffering state of a markup document using a content decoder and a cache manager, according to an embodiment of the present invention;

FIG. 17 is a diagram illustrating an interactive DVD on which AV data and markup documents are recorded, according to an embodiment of the present invention;

FIG. 18 is a diagram illustrating a directory structure of the interactive DVD shown in FIG. 17;

FIG. 19 is a diagram illustrating a volume structure and file structure of the interactive DVD shown in FIG. 17; and

FIG. 20 is a diagram illustrating a method of reproducing markup documents and AV data from the interactive DVD shown in FIG. 17, according to an embodiment of the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

Apparatuses for and methods of preloading data and deleting the preloaded data are disclosed by the present applicant in Korean Patent Application No. 2002-57393, filed on Sep. 19, 2002. While the disclosure thereof is incorporated herein by reference, the following description of the disclosure is presented to further illustrate the present invention.

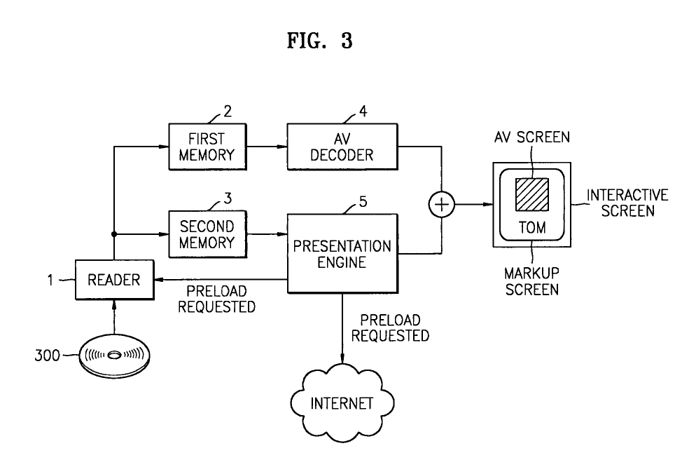

FIG. 3 shows an apparatus for reproducing data from a data storage medium that carries out a preloading or deleting operation with respect to markup documents. The apparatus supports an interactive mode, in which an AV data stream is reproduced from the data storage medium, for example, a DVD 300, by decoding AV data recorded on the DVD 300 and then displaying the decoded data in a display window defined by markup documents. The apparatus includes a reader 1, a first memory 2, a second memory 3, an AV decoder 4, and a presentation engine 5. During an interactive mode, an AV screen is displayed while being embedded in a markup screen. The markup documents are displayed in the markup screen, and the AV screen is obtained by reproducing the AV data.

The presentation engine 5 supports extensions to link tags, JavaScript, or Java Applet, so as to interpret and execute preload information written using link tags, the JavaScript application program interface (API), or the Java Applet API and deletion information written using the JavaScript API or the Java Applet API.

The reader 1 reads markup documents or AV data from the DVD 300. The first memory 2 is, for example, a buffer memory, and buffers the AV data read by the reader 1. The second memory 3 is, for example, a cache memory, and caches a received preload file. The AV decoder 4 decodes the AV data stored in the first memory 2 and outputs an AV data stream. The presentation engine 5 interprets the preload information, which is included in the markup documents read by the reader 1 and issues a request to the reader 1 or an Internet server (not shown) for files to be preloaded into the second memory 3 based on the interpreted preload information. To synchronize the display of the files and the AV data, the preloaded files are read from the second memory 3 and displayed together with the AV data stream output from the AV decoder 4. The files are deleted from the second memory 3 by interpreting deletion information.

The DVD 300 comprises audio data or AV data, and markup documents having preload information and/or deletion information. In addition, a preload-list file and/or a deletion-list file may be recorded on the DVD 300.

The preload-list file includes a list of files to be preloaded and the size of each file to be preloaded. The files to be preloaded represent markup documents, which are reproduced in synchronization with corresponding AV data. The files to be preloaded may be recorded on the DVD 300. The files to be preloaded, however, may also be stored in an Internet server that is accessible through the Internet.

Preload information comprises a command to read the files to be preloaded from, for example, the DVD 300 and then store the files in the cache memory 3. The preload information may be specified using a link tag, which includes the path and attributes of the preload-list file and is inserted into a head tag. On the other hand, the preload information may be specified using a JavaScript application program interface (API) or a Java Applet API, having the path and/or attribute of the preload-list file as function parameters and enabling the reproduction of the preload-list file. The preload information may also be specified using a JavaScript API or a Java Applet API, having the path and/or attribute of each file to be preloaded as function parameters and enabling the reproduction of files, in which case the preload-list file is unnecessary.

The deletion-list file includes a list of files to be deleted, with the location information of each file to be deleted, i.e., the file name and path of each file to be deleted. The deletion information represents a command to delete files from the second memory 3. The deletion information may be specified using a JavaScript API or a Java Applet API having the location information of the deletion-list file as a function parameter and enabling the deletion of files that are listed on the deletion-list file. On the other hand, the deletion information may be specified using a JavaScript API or a Java Applet API having the location information of each file to be deleted as a function parameter and enabling the deletion of files, in which case the deletion-list file is unnecessary.

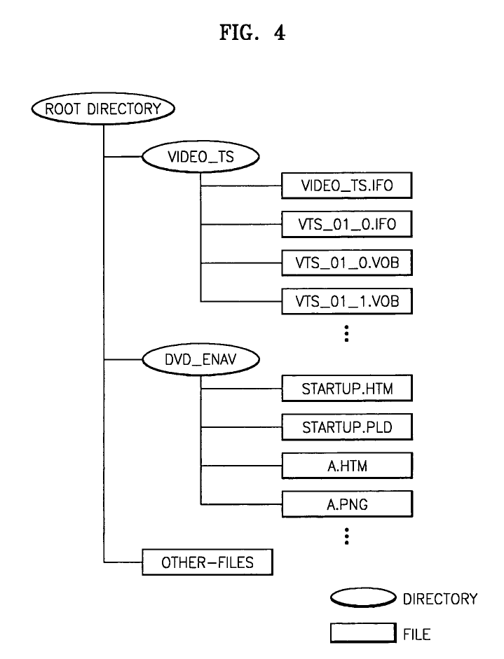

FIG. 4 shows a directory structure of the DVD 300. Referring to FIG. 4, a root directory includes a DVD video directory VIDEO_TS having AV data and a DVD interactive directory DVD_ENAV having data to support an interactive function.

Header information VIDEO_TS.IFO concerning all video titles recorded on the DVD 300, navigation information VTS_{—}01_{—}0.IFO for a first video title, and AV data VTS_{—}01_{—}0.VOB, VTS_{—}01_{—}1.VOB, . . . constituting a first video title are recorded in the DVD video directory VIDEO_TS. The detailed description of the structure of the DVD video directory VIDEO_TS is disclosed in the DVD-Video standard (DVD-Video for Read Only Memory Disc 1.0).

Navigation information DVD_ENAV.IFO regarding the entire interactive information and a start-up document STARTUP.HTM are recorded in the DVD interactive directory DVD_ENAV. In addition, a preload-list file STARTUP.PLD, a file to be preloaded A.HTM, and a graphic file A.PNG inserted into A.HTM are also provided in the DVD interactive directory DVD_ENAV. Other files to be preloaded or graphic files inserted thereto may also be recorded in the DVD interactive directory DVD_ENAV.

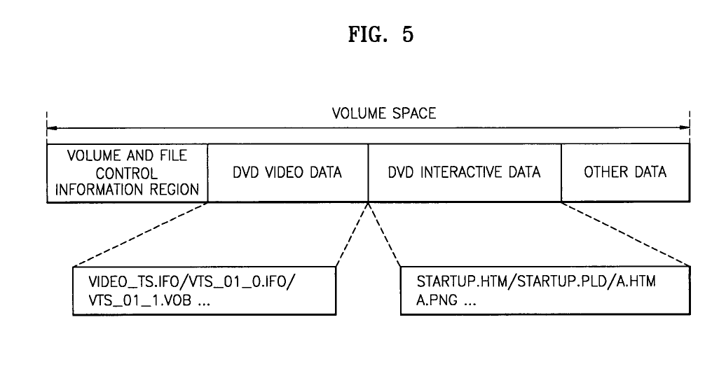

FIG. 5 shows a volume space of the DVD 300. Referring to FIG. 5, the volume space comprises a control information region which includes control information for the volume space of the DVD 300 and files recorded on the DVD 300, a DVD-Video data region where video title data is recorded, and a DVD-Interactive data region which is provided to reproduce AV data during an interactive mode.

The files stored in the DVD video directory VIDEO_TS of FIG. 4, i.e., VIDEO_TS.IFO, VTS_{—}01_{—}0.IFO, VTS_{—}010_{—}0.VOB, VTS_{—}01_{—}1.VOB, . . . , are recorded in the DVD-Video data region. The files stored in the DVD interactive directory DVD_ENAV, i.e., STARTUP.HTM, STARTUP.PLD, A.HTM, and A.PNG, are recorded in the DVD-Interactive data region.

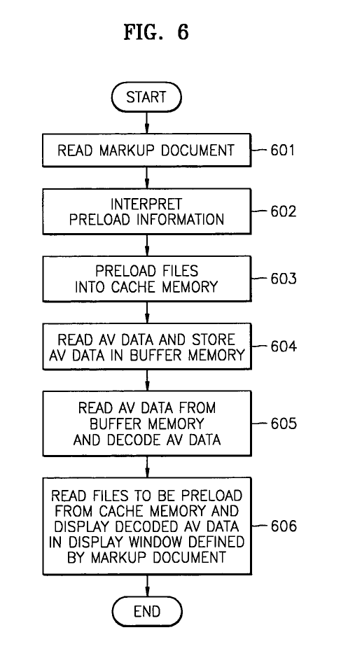

FIG. 6 illustrates a method of reproducing data from a data storage medium. In operation 601, the reader 1 reads an HTML document, which is a markup document recorded on the DVD 300, from the DVD 300 where an interactive mode is selected. In operation 602, the presentation engine 5 interprets preload information included in the HTML document and requests that the reader 1 or an Internet server preload files. In response to the request, files to be preloaded are stored in the second memory 3 in operation 603.

The reader 1 reads AV data, corresponding to the HTML document read in the operation 601, from the DVD 300 and stores the read AV data in the first memory 2, which is a buffer memory, in operation 604. The AV decoder 4 decodes AV data stored in the first memory 2 into an AV data stream in operation 605. In operation 606, the presentation engine 5 reads the preloaded files from the second memory 3 and displays the decoded AV data stream in a display window, which is defined by the HTML document read by the reader 1 in the operation 601.

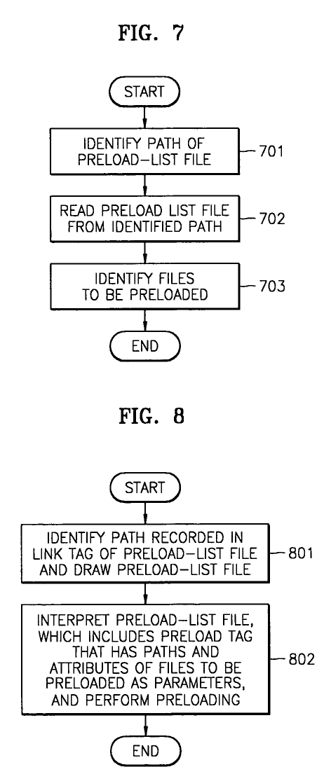

FIG. 7 illustrates a method of interpreting preload information, the method corresponding to the operation 602 of FIG. 6. In operation 701, the presentation engine 5 recognizes the path of a preload-list file included in an HTML document and reads the preload-list file by following the recognized path in operation 702. In operation 703, the presentation engine 5 recognizes the files to be preloaded, which are listed in the preload-list file. Here, recognition of the files to be preloaded indicates recognition of the paths and attributes of the files to be preloaded.

FIG. 8 illustrates a method of preloading files, the method corresponding to the operation 603 of FIG. 6. In operation 801, the presentation engine 5 identifies the path recorded in a link tag of the preload-list file and draws the preload-list file. In operation 802, the presentation engine 5 interprets the preload-list file, which includes a preload tag that has the paths and attributes of the files to be preloaded as parameters, and performs a preloading of the files.

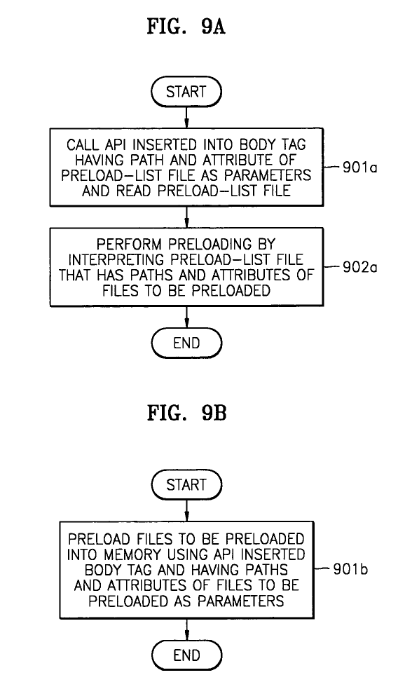

FIG. 9A illustrates another method of preloading files, the method corresponding to the operation 603 of FIG. 6. In operation 901a, the presentation engine 5 interprets the API inserted into a body tag using parameters specifying the paths of the files to be preloaded and reads the files to be preloaded using the API. In operation 901b, the presentation engine 5 performs a preloading by interpreting the preload-list file that includes the paths and attributes of the files to be preloaded. Since the presentation engine 5 can determine the attributes of the files to be preloaded, it can process the files to be preloaded based on their attributes and store the processed files in a memory.

FIG. 9B illustrates still another method of preloading files, the method corresponding to the operation 603 of FIG. 6. In operation 901b, the presentation engine 5 preloads files to be preloaded into a memory using the API inserted into a body tag and having the paths and attributes of the files to be preloaded as parameters. Since an attribute of a file to be preloaded is be identified, the presentation engine 5 may process the file to be preloaded in consideration of its attribute and then store the file to be preloaded in a memory.

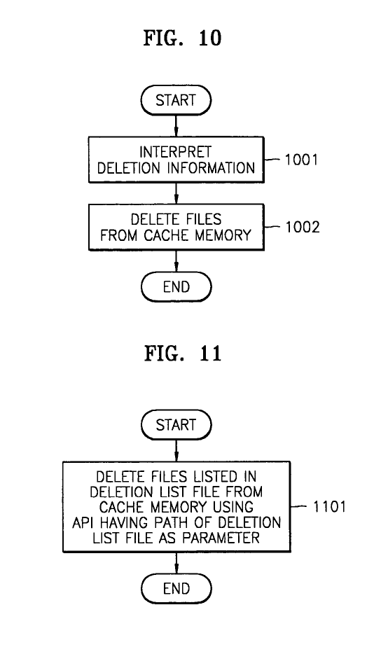

FIG. 10 illustrates a method of deleting one or more of the preloaded files that are stored in a memory. In operation 1001, the presentation engine 5 interprets deletion information included in an HTML document, identifies files to be deleted based on a deletion-list file, and deletes the identified files from the second memory 3 in operation 1002. While the preload-list file and the deletion-list file are integrated into a single file, i.e., STARTUP.PLD, it is understood that a list of files to be preloaded and a list of files to be deleted can be realized as two separate files rather than being integrated into a single file.

FIG. 11 illustrates a method of deleting one or more files from a cache memory, the method corresponding to the operation 1002 of FIG. 10. A list of files to be deleted may be recorded in the deletion-list file. In operation 1101, the files are deleted from the second memory 3 using an API, having the path of the deletion-list file as a parameter. Here, the deletion of the files may be a process of physically removing the files from the second memory 3, a process of including in the files a flag indicating that the files can be deleted from the second memory 3, or the files can be overwritten by other data without physically removing the files from the second memory 3.

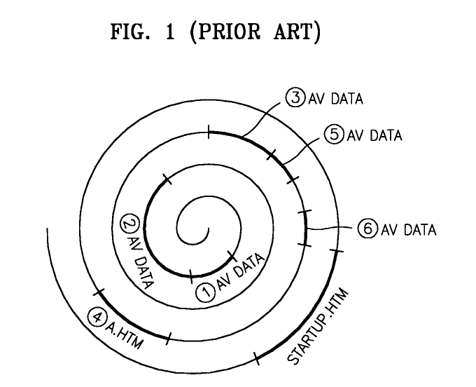

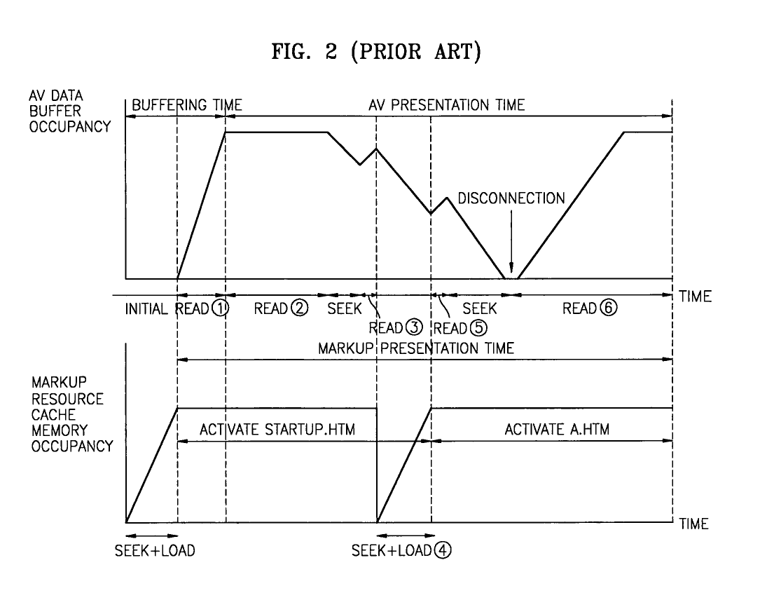

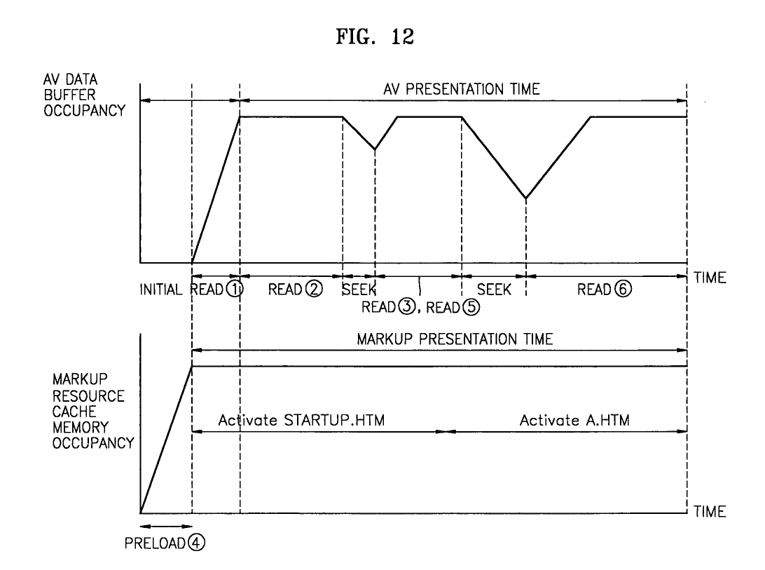

FIG. 12 illustrates the effects of a preloading process on an interactive DVD where AV data and HTML documents are recorded in the same manner as in FIG. 1. That is, FIG. 12 shows occupancy of the first memory 2 where MPEG-coded AV data is buffered and occupancy of the second memory 3 where a web resource is cached. Referring to FIGS. 1 and 12, the reader 1 searches for and reads STARTUP.HTM, and the presentation engine 5 interprets the preload information included in the STARTUP.HTM so that \mathring{4} A.HTM is preloaded into the second memory 3. Where the STARTUP.HTM, which is loaded into the second memory 3, is activated, \mathring{1} AV data is loaded into the first memory 2 and then displayed. Thereafter, \mathring{2} AV data is loaded into the first memory 2 and then displayed. Where buffering of the \mathring{2} AV data is completed, the reader 1 jumps to a place where \mathring{3} AV data is recorded and starts buffering the \mathring{3} AV data. At this time, where a user requests \mathring{4} A.HTM, the presentation engine 5 reads \mathring{4} A.HTM from the second memory 3 and displays the \mathring{4} A.HTM. In this case, there is no need for the reader 1 to stop the buffering of the \mathring{3} AV data, search the DVD 300 for the \mathring{4} A.HTM, and then load the document \mathring{4} A.HTM into the second memory 3. Therefore, the reader 1 can continue to buffer the \mathring{3} AV data. Where the reader 1 completes the buffering of \mathring{5} AV data and jumps to a place where \mathring{6} AV data is recorded, the amount of data buffered in the first memory 2 may be reduced. However, the amount of data that has been buffered in the first memory 2 is sufficient so that a shortage in buffered data does not occur. In other words, even where there is a need to display DVD-video images, reproduced from an interactive DVD during the interactive mode, in synchronization with HTML documents, the reader 1 does not have to stop the buffering of AV data and then search for and cache the HTML documents. This is because the HTML documents have already been preloaded in the second memory 3. For example, synchronization display may be used where there is a need to display a specific actor's or actress's personal history whenever he or she appears on a screen.

Again, the above-described apparatus, storage medium and processes of preloading data and deleting the preloaded data are taught by the present applicant in Korean Patent Application No. 02-57393 filed on Sep. 19, 2002. Hereinafter, a data storage medium and a method and apparatus for reproducing data from the data storage medium according to the present invention will be described.

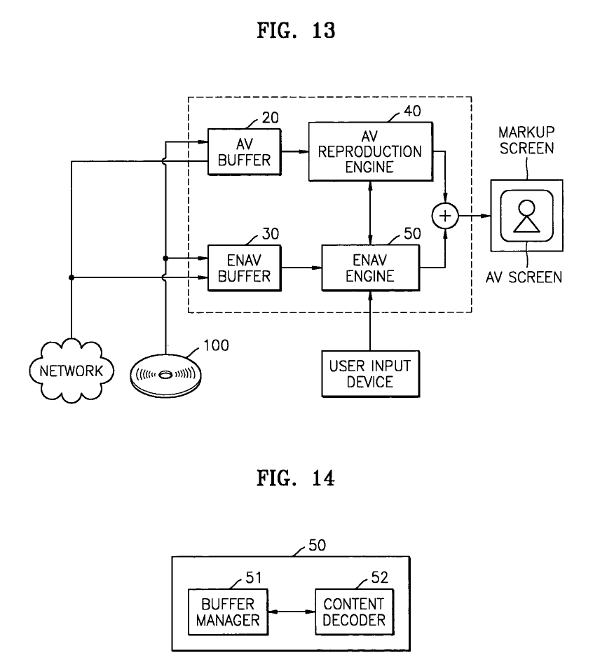

FIG. 13 shows a block diagram of an apparatus for reproducing data from a data storage medium according to an embodiment of the present invention. The apparatus of FIG. 13, similar to that of FIG. 3, reproduces data from a data storage medium. In addition, the apparatus of FIG. 13 supports an interactive mode, carries out a preloading, and includes an AV buffer 20, an AV reproduction engine 40, an enhanced audio and video (ENAV) buffer 30, and an ENAV engine 50.

The AV buffer 20, which corresponds to a first memory 2 of FIG. 3, buffers AV data read from a storage medium, for example, a disk 100, or a network, for example, the Internet. The AV reproduction engine 40 decodes the buffered AV data, thereby outputting an AV stream. The ENAV buffer 30, for example, is a cache memory corresponding to a second memory 3 of FIG. 3. The ENAV buffer 30 buffers markup documents read from the disk 100 or the network. The ENAV engine 50, which corresponds to the presentation engine 5 of FIG. 3, carries out a preloading and controls a buffering state of the markup documents stored in the ENAV buffer 30. In addition, the ENAV engine 50 interprets or decodes the markup documents stored in the ENAV buffer 30. The ENAV engine 50 allows the AV stream output from the AV reproduction engine 40 to be reproduced in an interactive mode.

FIG. 14 shows a detailed block diagram of the ENAV engine 50 of FIG. 13 according to an embodiment of the present invention. The ENAV engine 50 comprises a buffer manager 51 which controls the ENAV buffer 30 and a content decoder 52 which interprets the markup documents.

The content decoder 52 may comprise an interpretation engine which parses and interprets the markup documents, and a browser which draws the markup documents from the interpretation engine and/or the network. Here, the markup documents correspond to various kinds of markup resources, ranging from markup text data written in HTML, CSS, or JAVASCRIPT to binary data, such as image data, audio data, or a Java program, which is referred to by markup documents. The markup documents are drawn from the disk 100 or the network by the buffer manager 51 in the ENAV engine 50.

With respect to preloading or deleting of markup documents, the buffer manager 51 manages a buffering state of the markup documents in a predetermined manner according to the present invention. According to an embodiment of the present invention, the buffer manager 51 responds to a signal output from the content decoder 52. For example, the buffer manager 51 may operate differently in response to different signals output from the content decoder 52. The signals may include, for example, a fetch signal, a reproduce signal, a release signal, a discard signal, and a report signal.

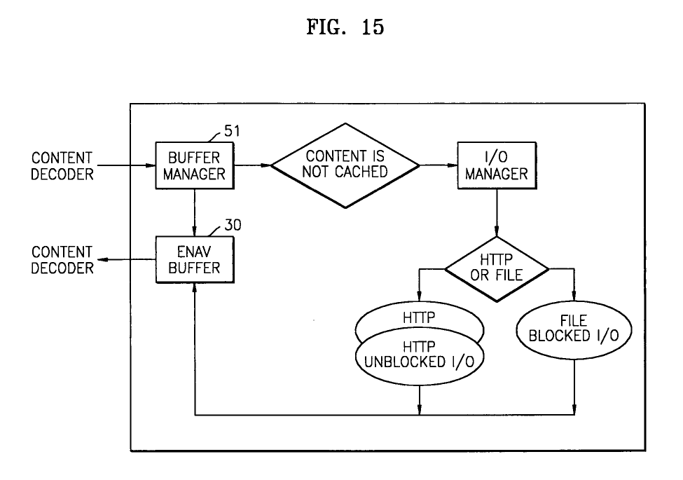

FIG. 15 shows the buffer manager 51 which manages a buffering state of markup documents processed by the ENAV buffer 30, according to an embodiment of the present invention. For example, five different signals, i.e., a fetch signal, a reproduce signal, a release signal, a discard signal, and a report signal, may be input into the buffer manager 51 from the content decoder 52.

A fetch signal is used to preload markup documents into the ENAV buffer 30. Where the markup documents are already preloaded into the ENAV buffer 30, an I/O manager may prevent the corresponding markup documents from being read from a disk or a network. The I/O manager represents a reader (not shown), which reads data from the disk, or a network data receiver/transmitter (not shown), which receives data from the network. The reader reads files from the disk, and the network data receiver/transmitter receives predetermined data from and/or transmits predetermined data to the network using, for example, a HTTP protocol.

Referring to FIG. 15, the I/O manager may be set to operate in the following manners. Where an HTTP request is issued, the I/O manager uses an unblocked I/O. Where a request for files on a disk is issued, the I/O manager uses a blocked I/O. To reproduce markup documents from a network, the I/O manager adopts an unblocked method so as to receive a plurality of markup documents at a given time. However, where a plurality of markup documents is read from a disk at a given time, a pickup device (not shown) in the reader is required to move between locations where the markup documents are recorded. Accordingly, the speed of reading the corresponding markup documents may be lowered by many times. Therefore, in the case where a plurality of markup documents is to be read from a disk, a sequential blocked I/O process is adopted, in which the plurality of markup documents are sequentially read from the disk.

A reproduce signal is used to issue a request to transfer data from the ENAV buffer 30 to the content decoder 52. Where predetermined data is read from a disk or downloaded from a network, the content decoder 52 may be blocked from operating until reading or downloading of the predetermined data is completed.

A release signal indicates that the predetermined data transferred from the ENAV buffer 30 to the content decoder 52, in response to the above-described reproduce signal, is no longer needed. For example, where a predetermined markup document is referred to five times in response to a reproduce signal, a release signal is generated five times. A counter value increases whenever a reproduce signal is generated and decreases whenever a release signal is generated. Where a counter value corresponding to a predetermine markup document reaches 0, i.e., where all reproduced markup documents are released, the released markup documents are deleted from the ENAV buffer 30 in response to a discard signal, which is described below.

A discard signal indicates that predetermined markup documents stored in the ENAV buffer 30 can be deleted from the ENAV buffer 30, for example, because they will not be used any more. Therefore, in response to the discard signal, the predetermined markup documents are discarded from the ENAV buffer 30.

According to an aspect of the present invention, where markup documents are associated with another application and a reproduce signal has been generated, but a release signal has not been generated, the markup documents cannot be deleted from the ENAV buffer 30, even where a discard signal has been generated by a predetermined application.

A report signal is used to verify, for example, whether markup documents read in response to a fetch signal are successfully loaded into the ENAV buffer 30, whether at least some of the corresponding markup documents cannot be read due to errors, and/or whether the corresponding markup documents are being read.

According to an embodiment of the present invention, the above and/or other signals of the present invention are provided using an API corresponding to, for example, a script written in a markup document. The followings, while not limited thereto, are examples of APIs used to generate a variety of signals utilized in the present invention.

<[obj].preload(URL, resType)>

Description:

This API is used to preload files, or read files and store the files in the ENAV buffer 30. Parameters of the API include location information of a preload-list file or location information of files to be preloaded, and attributes of the files to be preloaded. This API generates a fetch signal and may apply to all files that may be read from a disk (disc://) or a network (http://). It is understood that an API may be used to preload a file.

Parameters:

URL=: a path of the preload-list file or paths of the files to be preloaded

ResType=: attributes of the files to be preloaded

Return Values:

Where a preload commend is successfully executed, a value of 0 is returned. Otherwise, a value of −1 is returned. For example, where the preload commend is not executed successfully, a value of −1 is returned.

Examples:

A navigator.preload(“disc://dvd_enav/a.htm”, “texVxml”) request refers to a request to load files from “disc://dvd_enav/a.htm.” The files to be preloaded are text files written in XML.

A navigator.preload(“disc://dvd_enav/a.pid”, “xml/preload”) request refers to a request to load files listed in the preload-list file from “disc://dvd_enav/a.pid.” The files listed in the preload-list file are preload files written in XML.

<[obj].discard(URL, resType)>

Description:

This API is used to delete files from the ENAV buffer 30. Parameters of the API include location information of a deletion-list file or location information of files to be deleted, and attributes of the files to be deleted. This API generates a discard signal. It is understood that an API may be used to delete a file.

Parameters:

URL=: a path of the deletion-list file or paths of the files to be deleted

ResType=: attributes of the files to be deleted

Return Values:

Where a discard command is successfully executed, a value of 0 is returned. Otherwise, a value of −1 is returned. For example, where the discard command is not successfully executed, a value of −1 is returned.

Examples:

A navigator.discard(“disc://dvd_enav/a.htm”, “text/xml”) request refers to a request to delete files from “disc://dvd-enav/a.htm.” The files are text files written in XML.

A navigator.discard(“disc://dvd-enav/a.pld”, “xml/preload”) request refers to a request to delete files listed in the deletion-list file of “disc://dvd_enav/a.pld,” from the cache memory. The files are list files written in XML.

<[obj].isCached(URL, resType)>

Description:

This API is used to check, for example, whether files have been successfully stored/loaded in the ENAV buffer 30. Parameters of the API include location information of a list file or location information of the files to be searched for/checked, and attributes of the files to be checked. The API generates a report signal and may be applied to all files that are read from a disk (disc://) or a network (http://). It is understood that an API may be used to check the status of a file.

Parameters:

URL=: a path of the list file or paths of the files to be checked

resType=: attributes of the files to be checked

Return Values:

Where a file listed in the list file or a file to be checked is successfully stored/loaded in the ENAV buffer 30, a value of 0 is returned. Where the checked file is not successfully loaded, that is, preloading of the file failed, a value of 1 is returned. Where the file is still being read/loaded, or where during preloading of files no failure have occurred and at least one of the files is still being read/loaded, a value of 2 is returned.

Examples:

A navigator.isCached(“disc://dvd_enav/a.htm”, “text/xml”) request refers to a request to verify whether a file of “disc://dvd_enav/a.htm” has been stored. The file is a text file written in XML.

A navigator.isCached (“d isc:dvdenav/a.pd”, “xml/preload”) request refers to a request to verify whether files, referred to by the list file of “disc://dvd_enav/a.pld”, have been stored. The files are list files written in XML.

<[obj].progressNameOfFile>

Description:

This API is used to return, for example, a universal resource identifier (URI) of a file currently being preloaded.

Return Value: a file path or a URI

<[obj].progressLengthOfFile>

Description:

This API indicates how much of the file currently being preloaded has been preloaded.

Return Value: a value represented in a unit of byte

<[obj].remainLengthOfFile>

Description:

This API indicates how much of the file currently being preloaded is yet to be preloaded

Return value: a value represented in a unit of byte

<[obj].totalLoadingSize>

Description: This API indicates, for example, a total load of files to be preloaded.

Return value: a value represented in a unit of byte

<[obj].remainLoadingSize>

Description:

This API indicates, for example, how much of the total load of files to be preloaded is yet to be dealt with.

Return value: a value represented in a unit of byte

<[obj].allDone>

Description:

This API indicates, for example, whether an apparatus for reproducing data from a data storage medium has completed preloading.

Return values:

Where the apparatus has successfully completed the preloading, this API returns a value of TRUE. Otherwise, a value of FALSE is returned. For example, where the preloading is not completed, that is, where the preloading has failed or is in process, a value of FALSE is returned.

As described above, according to an aspect of the present invention, a reproduce signal and a release signal are generated whenever corresponding markup documents are used. For example, the content decoder 52 presents an image of “disc://dvd_enav/a.png” using a display device (not shown) by interpreting <img src=“disc://dvd_enav/a.png”/> and generating a reproduce signal so as to have the buffer manager 51 reproduce the corresponding image from the ENAV buffer 30. Likewise, the content decoder 52 generates a release signal where the presentation of the corresponding image is complete.

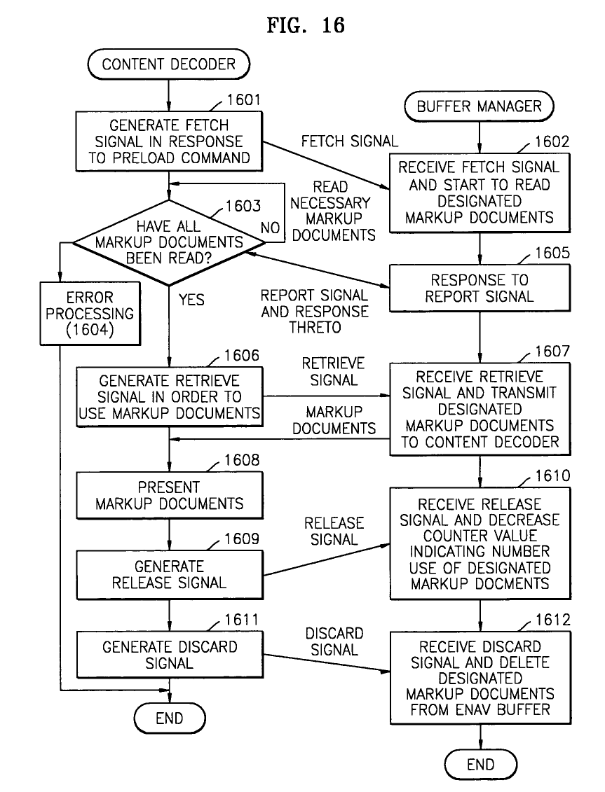

FIG. 16 illustrates a method of controlling a buffer state carried out by the content decoder 52 and the buffer manager 51, according to an embodiment of the present invention. In operation 1601, the content decoder 52 generates a fetch signal in response to a preload command. In operation 1602, the buffer manager 51 starts to read designated markup documents in response to the fetch signal. In operation 1603, the content decoder 52 determines, for example, whether all of the markup documents have been read and/or generates a report signal to determine, for example, a buffering state of the markup documents. In operation 1604, where an error occurs, the error is processed. In operation 1605, the buffer manager returns a signal indicating the buffering state of the markup documents in response to the report signal. In operation 1606, the content decoder 52 generates a retrieves signal to use the markup documents. In operation 1607, the buffer manager 51 transfers the designated markup documents to the content decoder 52 in response to the retrieve signal. In operation 1608, the content decoder 52 presented the designated markup documents. In operation 1609, where the designated markup documents are no longer to be used, the content decoder 52 generates a release signal. In operation 1610, the buffer manager 51 decreases a current value a counter by 1 to indicate, for example, use of a corresponding one/ones of the designated markup documents. In operation 1611, the content decoder 52 generates a discard signal to delete the designated markup documents. In operation 1612, the buffer manager 51 deletes the designated markup documents from the ENAV buffer 30 in response to the discard signal.

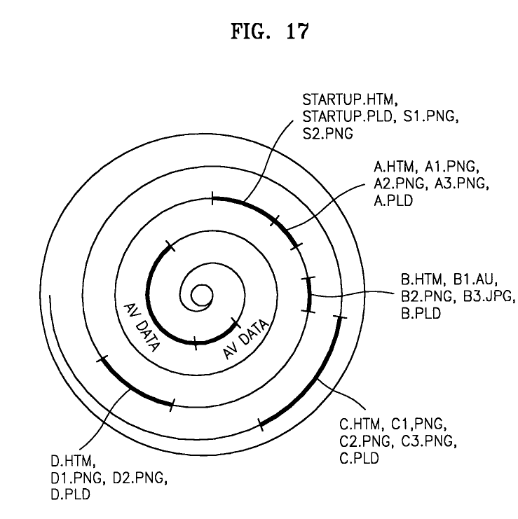

FIG. 17 illustrates a data storage medium, for example, a disk, on which AV data and markup documents are recorded, according to an embodiment of the present invention. The data storage medium further comprises control information which is used to identify buffering state information of a markup document to be preloaded. For example, a startup document STARTUP.HTM includes a preload list file STARTUP.PLD to seamlessly reproduce files ranging from A.HTM to D.HTM.

The control information may include an API that returns a value of 0 in response to preloading of the markup document being successful, a value of 1 in response to the preloading of the markup document being failed, and a value of 2 in response to the preloading of the markup document still being conducted. The control information may further include an API that generates a fetch signal to issue a command to preload the markup document. This API may return a response indicating whether the command to preload the markup document has been successfully transmitted. The control information may further include an API that is used to determine whether preloading of the markup document is completed. This API may return a value of TRUE in response to the preloading of the markup document being completed and a value of FALSE in response to the preloading of the markup document being not completed.

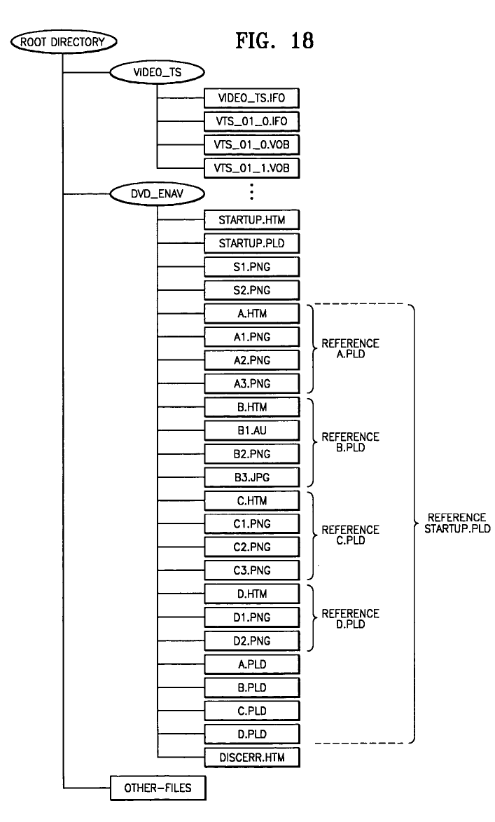

FIG. 18 illustrates a directory structure of the disk of FIG. 17 according to an embodiment of the present invention. Referring to FIG. 18, reference documents of the startup document STARTUP.PLD are included in a directory DVD_ENAV.

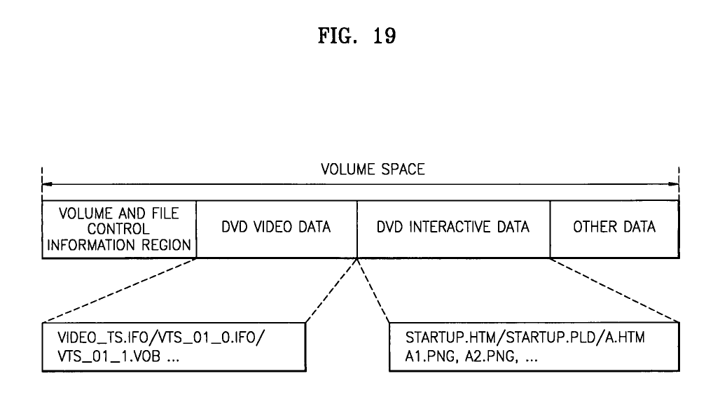

FIG. 19 illustrates a volume structure and file structure of the disk of FIG. 17 according to an embodiment of the present invention. Referring to FIG. 19, the reference documents of the STARTUP.PLD are recorded in a DVD interactive data area.

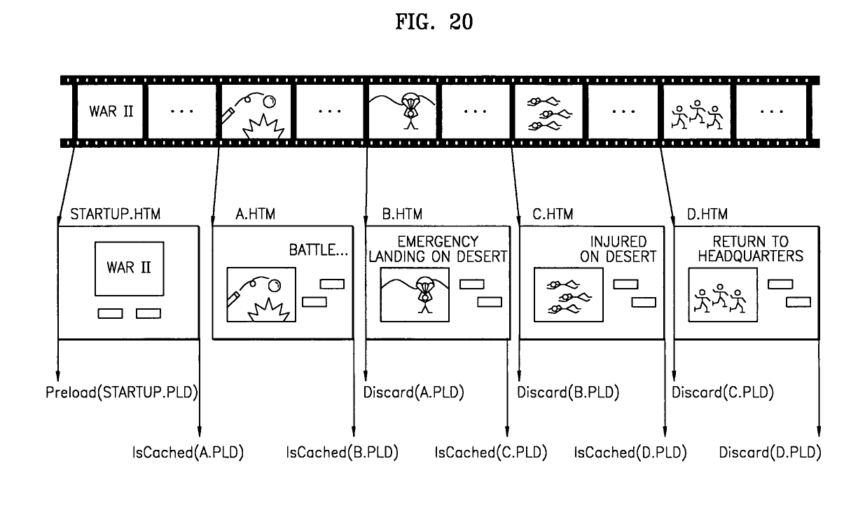

FIG. 20 illustrates a predetermined order in which the markup documents and the AV data recorded on the disk of FIG. 17 are reproduced. For example, where each scene begins, whether reference files of a preload list file corresponding to the scene have been read is checked using an IsCashed API. Where reading of the reference files has been successfully completed, HTM documents are read and reproduced. Thereafter, markup documents that have already been reproduced are discarded using a Discard API.

For example, to seamlessly reproduce data from STARTUP.HTM, A.HTM, and D.HTM, STARTUP.PLD is specified as follows.

<?xml version=“1.0” encoding=“UTF-8”?>
<!DOCTYPE PRELOAD PUBLIC
“-//DVD//DTD DVD Preload List 1.0//EN”
“http://www.dvdforum.org/enav/dvd-preload-list.dtd”-->
<filedef type=“text/xml” src=“disc://dvd_enav//a.htm” />
<filedef type=“text/xml” src=“disc://dvd_enav//a.pld” />
<filedef type=“image/png” src=“dvd://dvd_enav//a1.png” />
<filedef type=“image/png” src=“dvd://dvd_enav//a2.png” />
<filedef type=“image/png” src=“dvd://dvd_enav//a3.png” />
<filedef type=“text/xml” src=“disc://dvd_enav//b.htm” />
<filedef type=“text/xml” src=“disc://dvd_enav//b.pld” />
<filedef type=“audio/au” src=“dvd://dvd_enav//b1.au” />
<filedef type=“image/png” src=“dvd://dvd_enav//b2.png” />
<filedef type=“image/png” src=“dvd://dvd_enav//b3.jpg” />
<filedef type=“text/xml” src=“disc://dvd_enav//c.htm” />
<filedef type=“text/xml” src=“disc://dvd_enav//c.pld” />
<filedef type=“image/png” src=“dvd://dvd_enav//c1.png” />
<filedef type=“image/png” src=“dvd://dvd_enav//c2.png” />
<filedef type=“image/png” src=“dvd://dvd_enav//c3.png” />
<filedef type=“text/xml” src=“disc://dvd_enav//d.htm” />
<filedef type=“text/xml” src=“disc://dvd_enav//d.pld” />
<filedef type=“image/png” src=“dvd://dvd_enav//d1.png” />
<filedef type=“image/png” src=“dvd://dvd_enav//d2.png” />
</preload>

By using the above STARTUP.PLD, the STARTUP.HTM is displayed on a screen, indicating the start of the interactive presentation. An example of the STARTUP.HTM, which is processed by the apparatus of FIG. 15, is as follows.

<?xml version=“1.0” encoding=“UTF-8”?>
<!DOCTYPE html PUBLIC -//DVD/DTD XHTML DVD-HTML1.0//EN”
“http://www.dvdforum.org/enav/dvdhtml-1-0.dtd”>
<html>
<head>
<title>WAR II STARTUP PAGE</title>
<script language=“ecmascript”>
<![CDATA[
function onload_handler ( )
{
navigator.preload(“disc://dvd_enav/startup.pld”,“xml/preload”);
idplayer.subscribeToEvent(10)
idplayer.setTrigger(1,“00:30:35:00”,1);
idplayer.play( );
docbody.addEventListener(“dvdevent”,idplayer_handler,true);
}
function idplayer_handler(e)
{
switch(e.parm1)
{
case 10: .// trigger event

if (e.parm2 = = 1) // begin to die
{

while (navigator.isCached(“disc://dvd_enav/a.pld”,“xml/preload”) = = 2

∥ navigator.isCached(“disc://dvd_enav/b.pld”,“xml/preload”) = = 2
∥ navigator.isCached(“disc://dvd_enav/c.pld”,“xml/preload”) = = 2
∥ navigator.isCached(“disc://dvd_enav/d.pld”,“xml/preload”) = = 2); // during
//reading;

if (navigator.isCached(“disc://dvd enav/a.pld”,“xml/preload”) = = 1) // failed
{

idplayer.stop( );
location.href = “disc://dvd_enav/discerr.htm”;

}

// to read c.pld is OK.

location.href = “disc://dvd_enav/a.htm”; // jump to c.htm
}
break;

}

}
]]>
</script >
</head>
<body id=“docbody” onload=“onload_handler ( )”>
<object style=“position: absolute; left: 150px; top: 100px; width: 370px; height: 250px”
data=“dvd:video_ts” id=“idplayer”/>
<img style=“position: absolute; left: 167px; top: 375px; width: 170px; height: 60px” src=“
disc://dvd_enav/s1.png” type=“image/png”/>
<img style=“position: absolute; left: 370px; top: 375px; width: 170px; height: 60px” src=“
disc://dvd_enav/s2.png” type=“image/png”/>
</body>
</html>

According to an aspect of the present invention, the markup documents A.HTM and B.HTM may include images. According to an aspect of the present invention, with reference to FIGS. 18 and 20, markup documents necessary to present, for example, A.HTM, that is, all markup documents in A.PLD and mentioned as files to be preloaded, are deleted from the ENAV buffer 30 after the presentation.

<?xml version=“1.0” encoding=“UTF-8”?>
<!DOCTYPE html PUBLIC -//DVD/DTD XHTML DVD-HTML1.0//EN”
“http://www.dvdforum.org/enav/dvdhtml-1-0.dtd”>
<html>
<head>
<title>WAR II B.HTM PAGE</title>
<script language=“ecmascript”>
<![CDATA[
function onload_handler ( )
{
navigator.discard (“disc://dvd_enav/a.pld”,“xml/preload”); // any longer to use A.HTM
idplayer.subscribeToEvent(10)
idplayer.setTrigger(1,“50:35:00”,1);
docbody.addEventListener(“dvdevent”,idplayer_handler,true);
}
function idplayer_handler(e)
{
switch(e.parm1)
{
case 10: // trigger event

if (e.parm2 = = 1) // begin combat
{

while (navigator.isCached(“disc://dvd_enav/c.pld”,“xml/preload”) = = 2); // during

//reading;

if (navigator.isCached(“disc://dvd_enav/c.pld”,“xml/preload”) = = 1) // failed
{

idplayer.stop( );
location.href = “disc://dvd_enav/discerr.htm”;

}

// to read a.pld is OK.

location.href = “disc://dvd_enav/c.htm”; // jump to c.htm
}
break;

}

}
]]>
</script>
</head>
<body id=“docbody” onload=“onload_handler ( )”>
<object style=“left: 110px; top: 80px; width: 500px; height: 200px” data=“dvd:video_ts”
id=“idplayer”/>
<img style=“position: absolute; left: 539px; top: 38px; width: 140px; height: 70px” src=“
disc://dvd_enav/b1.png” type=“image/png” />
<img style=“position: absolute; left: 560px; top: 200px; width: 120px; height: 50px” src=“
disc://dvd_enav/b2.png” type=“image/png” />
<img style=“position: absolute; left: 610px; top: 280px; width: 100px; height: 50px” src=”
disc://dvd enav/b3.png” type=“image/png” />
</body>
</html>

For example, according to the present invention, images may be presented using only preloaded files as content is processed using a method which enables determination of the preloaded content state, even where physical defects of a disk or connection disruptions cause unsuccessful or incomplete preloading of files into a buffer. Accordingly, the reliability of reproducing the content is improved. That is, according to an aspect of the present invention, AV data may be presented in an appropriate manner in an interactive mode even though the markup documents have not been entirely preloaded or an error occurs during preloading of the markup documents.

It is understood that a system which uses the present invention also includes permanent or removable storage, such as magnetic and optical discs, RAM, ROM, a carrier wave medium, etc., on which the process and data structures of the present invention can be stored and distributed. The operations can also be distributed via, for example, downloading over a network such as the Internet.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus for reproducing AV data using a markup document in an interactive mode, comprising:
a buffer which buffers the markup document; and
a buffer manager which manages the buffer to preload the markup document and outputs buffering state information of the buffer in response to a report signal.

2. The apparatus of claim 1 further comprising a content decoder which interprets the markup document and outputs the report signal, wherein the buffer manager informs the content decoder of the buffering state information of the buffer in response to the report signal.

3. The apparatus of claim 2, wherein the content decoder generates the report signal using an application program interface (API).

4. The apparatus of claim 3, wherein the API serves to notify the content decoder of whether preloading of the markup document succeeded or failed, or whether the markup document is still being loaded.

5. The apparatus of claim 4, wherein the API returns a value of 0 where the preloading of the markup document succeeded, returns a value of 1 where the preloading of the markup document failed, and returns a value of 2 where the markup document is still being loaded.

6. The apparatus of claim 2, wherein the content decoder generates the report signal using an API, which includes at least one of a file path and an attribute of the markup document as a parameter.

7. The apparatus of claim 2, wherein the content decoder generates the report signal using an [obj].isCached(URL, resType) API, where the URL is a parameter indicating a file path of the markup document and the resType is a parameter indicating an attribute of the markup document.

8. The apparatus of claim 2, wherein the buffer manager informs the content decoder of a buffering state of the markup document utilizing an API.

9. The apparatus of claim 1, further comprising a content decoder which interprets the markup document, wherein the buffer manager transfers the markup document from the buffer to the content decoder in response to a reproduce signal.

10. The apparatus of claim 1 further comprising a content decoder which interprets the markup document, wherein the content decoder outputs a release signal to the buffer manager indicating that the markup document therein brought from the buffer, in response to a reproduce signal, is not in use.

11. The apparatus of claim 10, wherein the content decoder outputs the release signal to the buffer manager in response to the markup document no longer being displayed in a screen of a display device.

12. The apparatus of claim 1 further comprising a content decoder which interprets the markup document, wherein the buffer manager deletes the markup document from the buffer in response to a discard signal output from the content decoder.

13. The apparatus of claim 12, wherein the content decoder generates the discard signal using a discard API.

14. The apparatus of claim 2, wherein the content decoder generates the report signal using a progressNameOfFlle API to determine a file name of the markup document currently being preloaded.

15. The apparatus of claim 2, wherein the content decoder generates the report signal using a progressLengthOfFile API to determine how much of the markup document currently being preloaded has been preloaded.

16. The apparatus of claim 2, wherein the content decoder generates the report signal using a remainLengthOfFile API to determine out how much of the markup document currently being preloaded is yet to be preloaded.

17. The apparatus of claim 2, wherein the content decoder generates the report signal using a totalLoadingSize API to determine a total load of the markup document to be preloaded.

18. The apparatus of claim 2, wherein the content decoder generates the report signal using a remainLoadingSize API to determine how much of a total load of the markup document is yet to be preloaded.

19. An apparatus for controlling a buffer which buffers a markup document to reproduce AV data in an interactive mode, comprising a buffer manager which manages the buffer to preload the markup document and outputs information of the buffer including buffering information of the markup document, wherein the buffering information includes:
information indicating that preloading of the markup document succeeded;
information indicating that the preloading of the markup document failed; and
information indicating that the preloading of the markup document is still be conducted.

20. The apparatus of claim 19, wherein the buffer manager outputs the information of the buffer using an application program interface.

21. The apparatus of claim 19, wherein the information of the buffer further includes information indicating whether a command to preload the markup document has been successfully received.

22. The apparatus of claim 19, wherein the information of the buffer further includes information indicating whether preloading of the markup document is completed.

23. An apparatus for recording and/or reproducing AV data using a markup document in an interactive mode, comprising:
an AV buffer which buffers the AV data;
an AV reproduction engine which decodes the AV data;
an enhanced audio video (ENAV) buffer which preloads the markup document to reproduce the AV data in the interactive mode;
an ENAV engine which identifies buffering state information of the markup document and decodes the markup document; and
means for obtaining the markup document.

24. The apparatus of claim 23, wherein the apparatus uses a blocked I/O method in response to obtaining the markup document from a data storage medium and an unblocked I/O method in response to obtaining the markup document from a network.
